(19) United States
(12) Patent Application Publication
(10) Pub. No.: US 2023/0392730 A1
(43) Pub. Date: Dec. 7, 2023

(54) KOHNG NIPPLE

(71) Applicants: Korey Guy Clifford Doiron, Timmins (CA); Jonathon Eric Desormeaux, Timmins (CA)

(72) Inventors: Korey Guy Clifford Doiron, Timmins (CA); Jonathon Eric Desormeaux, Timmins (CA)

(21) Appl. No.: 17/833,864

(22) Filed: Jun. 6, 2022

(51) Int. Cl. F16L 33/24

(52) U.S. Cl. CPC F16L 33/24

(57) ABSTRACT

The present invention relates to a connector (also referred to as a “nipple”) for connecting two super high-pressure PSI hoses. Existing nipples used in the mining industry are difficult to remove from adjacent hoses if they become damaged or worn out and have to be replaced. Additionally, existing nipples in the mining industry can become damaged if the connection between the nipple and adjacent hoses is loosened so that adjacent hoses can be examined or replaced. In a first embodiment, a nipple for connecting hoses is disclosed and comprises: a first end; a second end, spaced apart from the first end; a central bore between the first end and the second end; and a hexagonal portion positioned between the first end and the second end of the nipple. Preferably, the hexagon portion is positioned equidistant between the first end of the nipple and the second end of the nipple.

### TECHNICAL FIELD

The present invention relates to a connector for connecting two super high-pressure PSI hoses. Preferably, the connector comprises a wrench adapter and is adapted for use in mining operations.

### BACKGROUND OF THE INVENTION

Connectors (also referred to as “nipples”) are short pieces of steel used to connect two hoses. In the mining industry, these hoses and nipples carry water and air. Existing nipples used in the mining industry are difficult to remove from adjacent hoses if they become damaged or worn out and have to be replaced. Additionally, existing nipples in the mining industry can become damaged if the connection between the nipple and adjacent hoses is loosened so that adjacent hoses can be examined or replaced. During the loosening process, a miner may hit the rock wall of the mine and/or steel equipment in the process of trying to crack the nut to get the mining nipple lose. This can result in injury to the miner and also creates additional cost to replace the damaged steel equipment. Existing mining nipples cannot be removed with a standard pipe wrench. An improved mining nipple is needed which is safe to use, more time efficient to use, and produces less waste.

### SUMMARY OF THE INVENTION

The present invention seeks to provide a nipple, having an improved connector design, to be used between super high-pressure PSI hoses. Preferably, in the mining industry. The nipple of the present invention is more reliable and longer lasting than current nipples that tend to get destroyed and require replacement when using a pipe wrench for hose separation.

Preferably, the nipple of the present invention has a tubular design and preferably is double reamed to create a larger seating surface. Preferably, the nipple has external threads at opposite ends of the nipple for connection to two separate high-pressure hoses. Preferably, the nipple is tapered at each end. Preferably, the mining has a raised hexagonal portion equidistant between the first end of the nipple and the second end of the nipple.

The hexagonal portion can be easily gripped with a wrench. Preferably, the nipple is threaded at both ends and hollow throughout. The nipple has the same circumference at a first end and at a second end, but can nevertheless connect to hoses of different diameter, for example 1 inch hoses and 0.5 inch hoses. Preferably, the nipple is about 2.9 inches long and 1 inch in diameter. Preferably, the nipple comprises Q235 steel and is about 1 inch long to about 2.9 inches long.

With a wrench gripping the center of the nipple, a miner could select which side of the hose to remove while using a second wrench on said hose. This makes it much easier to disconnect or connect two hoses as compared to existing mining nipples. The mining nipple of the present invention saves time and effort for miners while also avoiding costly repeated replacement of high—pressure hose nipples due to damage.

Other aspects and features according to the present application will become apparent to those ordinarily skilled in the art upon review of the following description of embodiments of the invention in conjunction with the accompanying figure.

### BRIEF DESCRIPTION OF THE DRAWINGS

The principles of the invention may better be understood with reference to the accompanying figure provided by way of illustration of an exemplary embodiment, incorporating principles and aspects of the present invention, and in which:

FIG. 1 shows a front perspective view of an embodiment of the mining nipple.

### DETAILED DESCRIPTION OF THE INVENTION

The description that follows and the embodiments described therein serve as either illustrations or examples of particular embodiments of the principles of the present invention. They are provided for the purposes of explanations and are not to be interpreted as limitations of those principles and of the invention. In the description, like parts are marked throughout the specification and the drawings with the same respective reference characters. The drawings are not necessarily to scale and in some instances, proportions may have been exaggerated to clearly illustrate certain features of the invention.

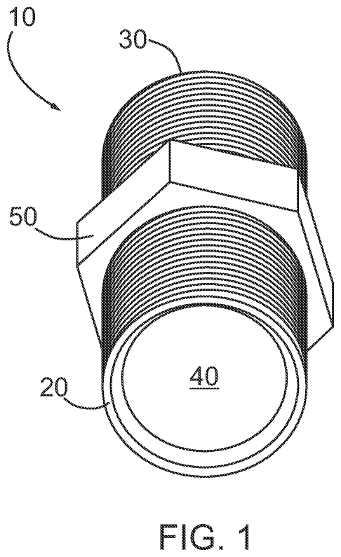

Referring to FIG. 1, an embodiment of the mining nipple (10) is shown. The mining nipple (10) comprises a first end (20) and a second end (30) and a central bore (40) therebetween. Preferably, each of the first end (20) and the second end (30) are double reamed and contain external treading for connection to super high-pressure PSI hoses. Preferably, the mining nipple (10) comprises a hexagonal region (50) in the centre of the mining nipple (10). The hexagonal region (50) is configured and adapted to be gripped by a wrench (not shown). Although a hexagonal shaped-region is preferred, other shapes that are readily gripped by a standard pipe wrench could be used. In an embodiment, the mining nipple is made from Q235 steel in the shape of a round bar. Preferably, the mining nipple (10) is one piece and preferably, the hexagonal portion (50) is integral therewith.

To operate the mining nipple (10), a first super high-pressure PSI hose (not shown) is hand threaded to the first end (20) of the mining nipple (10). Preferably, a whip check (not shown) is employed between the first end (20) of the mining nipple (10) and the first super-high pressure hose. A second super high-pressure PSI hose (not shown) is then threaded onto the second end (30) of the mining nipple (10). Two wrenches are used to tighten the connection: one wrench is positioned at the hexagonal portion (50) and the second wrench is positioned at the end of the second super high-pressure PSI hose. To remove the super high-pressure PSI hoses from the mining nipple (10), the above steps are performed in reverse.

Preferably, the mining nipple (10) comprises Q235 steel. However, other materials know to the person of skill in the art, and capable of withstanding high pressures could be used. In an embodiment, the mining nipple is made from Q235 steel in the shape of a round bar. Said round bars are heated and then forged into a blank shape. The blank shape is then subjected to a computer numerical control (CNC) lathe to process the threads and create the hexagonal portion.

Various embodiments of the invention have been described in detail. Since changes in and or additions to the above-described best mode may be made without departing from the nature, spirit or scope of the invention, the invention is not to be limited to those details but only by the appended claims. Section headings herein are provided as organizational cues. These headings shall not limit or characterize the invention set out in the appended claims.

### TECHNICAL FIELD

The present invention relates to a connector for connecting two super high-pressure PSI hoses. Preferably, the connector comprises a wrench adapter and is adapted for use in mining operations.

### BACKGROUND OF THE INVENTION

Connectors (also referred to as “nipples”) are short pieces of steel used to connect two hoses. In the mining industry, these hoses and nipples carry water and air. Existing nipples used in the mining industry are difficult to remove from adjacent hoses if they become damaged or worn out and have to be replaced. Additionally, existing nipples in the mining industry can become damaged if the connection between the nipple and adjacent hoses is loosened so that adjacent hoses can be examined or replaced. During the loosening process, a miner may hit the rock wall of the mine and/or steel equipment in the process of trying to crack the nut to get the mining nipple lose. This can result in injury to the miner and also creates additional cost to replace the damaged steel equipment. Existing mining nipples cannot be removed with a standard pipe wrench. An improved mining nipple is needed which is safe to use, more time efficient to use, and produces less waste.

### SUMMARY OF THE INVENTION

The present invention seeks to provide a nipple, having an improved connector design, to be used between super high-pressure PSI hoses. Preferably, in the mining industry. The nipple of the present invention is more reliable and longer lasting than current nipples that tend to get destroyed and require replacement when using a pipe wrench for hose separation.

Preferably, the nipple of the present invention has a tubular design and preferably is double reamed to create a larger seating surface. Preferably, the nipple has external threads at opposite ends of the nipple for connection to two separate high-pressure hoses. Preferably, the nipple is tapered at each end. Preferably, the mining has a raised hexagonal portion equidistant between the first end of the nipple and the second end of the nipple. The hexagonal portion can be easily gripped with a wrench. Preferably, the nipple is threaded at both ends and hollow throughout. The nipple has the same circumference at a first end and at a second end, but can nevertheless connect to hoses of different diameter, for example 1 inch hoses and 0.5 inch hoses. Preferably, the nipple is about 2.9 inches long and 1 inch in diameter. Preferably, the nipple comprises Q235 steel and is about 1 inch long to about 2.9 inches long.

With a wrench gripping the center of the nipple, a miner could select which side of the hose to remove while using a second wrench on said hose. This makes it much easier to disconnect or connect two hoses as compared to existing mining nipples. The mining nipple of the present invention saves time and effort for miners while also avoiding costly repeated replacement of high—pressure hose nipples due to damage.

Other aspects and features according to the present application will become apparent to those ordinarily skilled in the art upon review of the following description of embodiments of the invention in conjunction with the accompanying figure.

### BRIEF DESCRIPTION OF THE DRAWINGS

The principles of the invention may better be understood with reference to the accompanying figure provided by way of illustration of an exemplary embodiment, incorporating principles and aspects of the present invention, and in which:

FIG. 1 shows a front perspective view of an embodiment of the mining nipple.

### DETAILED DESCRIPTION OF THE INVENTION

The description that follows and the embodiments described therein serve as either illustrations or examples of particular embodiments of the principles of the present invention. They are provided for the purposes of explanations and are not to be interpreted as limitations of those principles and of the invention. In the description, like parts are marked throughout the specification and the drawings with the same respective reference characters. The drawings are not necessarily to scale and in some instances, proportions may have been exaggerated to clearly illustrate certain features of the invention.

Referring to FIG. 1, an embodiment of the mining nipple (10) is shown. The mining nipple (10) comprises a first end (20) and a second end (30) and a central bore (40) therebetween. Preferably, each of the first end (20) and the second end (30) are double reamed and contain external treading for connection to super high-pressure PSI hoses. Preferably, the mining nipple (10) comprises a hexagonal region (50) in the centre of the mining nipple (10). The hexagonal region (50) is configured and adapted to be gripped by a wrench (not shown). Although a hexagonal shaped-region is preferred, other shapes that are readily gripped by a standard pipe wrench could be used. In an embodiment, the mining nipple is made from Q235 steel in the shape of a round bar. Preferably, the mining nipple (10) is one piece and preferably, the hexagonal portion (50) is integral therewith.

To operate the mining nipple (10), a first super high-pressure PSI hose (not shown) is hand threaded to the first end (20) of the mining nipple (10). Preferably, a whip check (not shown) is employed between the first end (20) of the mining nipple (10) and the first super-high pressure hose. A second super high-pressure PSI hose (not shown) is then threaded onto the second end (30) of the mining nipple (10). Two wrenches are used to tighten the connection: one wrench is positioned at the hexagonal portion (50) and the second wrench is positioned at the end of the second super high-pressure PSI hose. To remove the super high-pressure PSI hoses from the mining nipple (10), the above steps are performed in reverse.

Preferably, the mining nipple (10) comprises Q235 steel. However, other materials know to the person of skill in the art, and capable of withstanding high pressures could be used. In an embodiment, the mining nipple is made from Q235 steel in the shape of a round bar. Said round bars are heated and then forged into a blank shape. The blank shape is then subjected to a computer numerical control (CNC) lathe to process the threads and create the hexagonal portion.

Various embodiments of the invention have been described in detail. Since changes in and or additions to the above-described best mode may be made without departing from the nature, spirit or scope of the invention, the invention is not to be limited to those details but only by the appended claims. Section headings herein are provided as organizational cues. These headings shall not limit or characterize the invention set out in the appended claims.

1. A nipple for connecting hoses comprising:
a first end;
a second end, spaced apart from the first end;
a central bore between the first end and the second end; and
a hexagonal portion positioned between the first end and the second end of the nipple.

2. The nipple of claim 1 wherein the hexagon portion is positioned equidistant between the first end of the nipple and the second end of the nipple.

3. The nipple of claim 1, wherein the nipple comprises Q235 steel.

4. The nipple of claim 1, wherein at least one of the first end of the nipple and the second end of the nipple are double reamed.

5. The nipple of claim 1, wherein the first end of the nipple and the second end of the nipple are externally threaded.

6. The nipple of claim 1, wherein the length of the nipple is about 2.9 inches and the diameter of the nipple is about 1 inch.

7. Use of the nipple of any one of claims 1-6 in a mining operation.
